(19) United States
(12) Patent Application Publication
(10) Pub. No.: US 2016/0300276 A1
(43) Pub. Date: Oct. 13, 2016

(54) SYSTEM AND METHOD FOR PROVIDING ACCESS TO PRODUCT REVIEWS AND/OR RATINGS

(71) Applicant: W.W. Grainger, Inc., Lake Forest, IL (US)

(72) Inventors: Hala Farouk El-Hmayssi, Chicago, IL (US); Geoffry A. Westphal, Evanston, IL (US)

(21) Appl. No.: 15/188,308

(22) Filed: Jun. 21, 2016

Related U.S. Application Data
(63) Continuation of application No. 13/715,331, filed on Dec. 14, 2012.

(51) Int. Cl. G06Q 30/02; G06Q 50/00

(52) U.S. Cl. CPC G06Q 30/0282; G06Q 50/01

(57) ABSTRACT

A system causes an image of a product and a ratings dashboard to be presented on a client computing device. Interaction with the ratings dashboard causes a quick review summary for the product to be presented. The quick review summary for the product provides a top line visual summary of review information provided by product reviewers which information includes a visualization of at least a number of product reviewers that have given the product each of a plurality of overall product reviewer ratings and a visualization of an average overall product reviewer rating of at least one characteristic of the product. Interaction with the quick review summary for the product may be used to cause a presentation of a more detailed summary of the product reviewer information for the product or information related to all product reviewer reviews for the product which information is further capable of being at least one of sorted and filtered.

### RELATED APPLICATION INFORMATION

This application claims the benefit of and is a continuation of U.S. application Ser. No. 13/715,331, filed on Dec. 14, 2012, the disclosure of which is incorporated herein by reference in its entirety.

### BACKGROUND

Computer-implemented methods and systems for allowing users to collaborate in evaluating products over a public network, such as the Internet, are known. By way of example, U.S. Pat. No. 8,249,915, issued on Aug. 21, 2012 and entitled “Computer-Implemented Method and System For Collaborative Product Evaluation,” describes a system that allows users to assign ratings/comments to features of a product and a system wherein such user-submitted ratings/comments can be qualified (or moderated) by other users. Such moderation is accomplished on a per-rating/per-comment basis by user selection of one label from a set of labels that represent different levels of perceived credibility of the user that submitted the rating/comment. A moderation score for a rating/comment is derived from the user-selected moderation labels pertaining to the rating/comment. Registered users preferably can assign weights to features, the weights representing the importance of that feature to the particular user. The user-supplied ratings as well as the moderation scores and/or weights corresponding thereto are used to compute composite ratings for user-selected product features that are communicated to the users for evaluation of the user-selected product features.

### SUMMARY OF THE INVENTION

The following describes a system and method that causes an image of a product and a ratings dashboard to be presented on a client computing device. Interaction with the ratings dashboard causes a quick review summary for the product to be presented. The quick review summary for the product provides a top line visual summary of review information provided by product reviewers which information includes a visualization of at least a number of product reviewers that have given the product each of a plurality of overall product reviewer ratings and a visualization of an average overall product reviewer rating of at least one characteristic of the product. Interaction with the quick review summary for the product may be used to cause a presentation of a more detailed summary of the product reviewer information for the product or information related to all product reviewer reviews for the product which information is further capable of being at least one of sorted and filtered.

While the forgoing provides a general explanation of the subject invention, a better understanding of the objects, advantages, features, properties and relationships of the subject invention will be obtained from the following detailed description and accompanying drawings which set forth illustrative embodiments and which are indicative of the various ways in which the principles of the subject invention may be employed.

### BRIEF DESCRIPTION OF THE DRAWINGS

For a better understanding of the subject invention, reference may be had to preferred embodiments shown in the attached drawings in which:

FIG. 1 is a block diagram illustrating components of an exemplary network system in which the methods described hereinafter may be employed;

FIG. 2 illustrates an exemplary product detail page having an exemplary ratings dashboard;

FIG. 3 illustrates an exemplary product review quick-view display being shown in an exemplary pop-up window in response to a user interaction with the product detail page of FIG. 2;

FIG. 4 illustrates an exemplary reviews summary display;

FIG. 5 illustrates an exemplary all reviews detail display;

FIG. 6 illustrates an exemplary display for gather information related to a product review; and

FIG. 7 illustrates an exemplary product review quick-view display being shown in an exemplary pop-up window in response to a user interaction with a product merchandizing area of a page.

### DETAILED DESCRIPTION

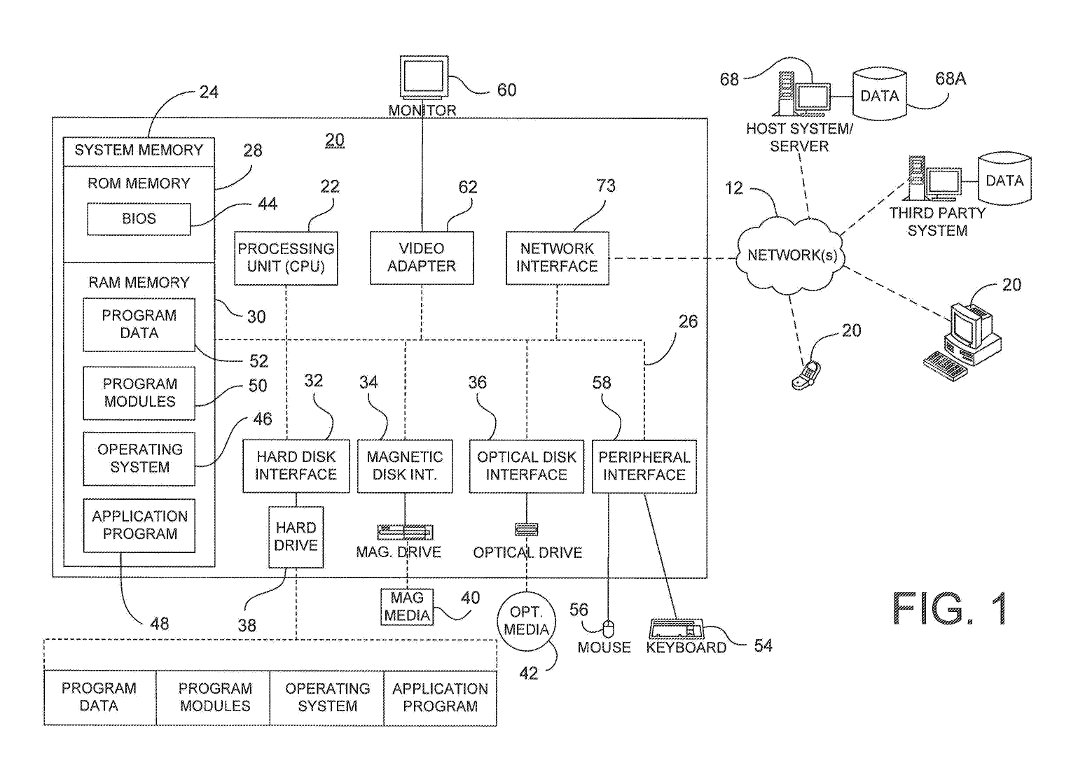

With reference to the figures, a system and methods are hereinafter described for allowing users to rate features of a product, for allowing users to comment on features of a product, and for quickly displaying such user ratings/comments as appropriate. As described in greater detail below, users are preferably allowed to rate pre-defined characteristics of a product, e.g., characteristics of a product pre-selected by a vendor of product, and/or to rate user-defined characteristics of a product. While not intended to be limiting, the methods described hereinafter which provide for the rating of such product characteristics are implemented on a computing system which is illustrated, by way of example only, in FIG. 1.

Turning to FIG. 1, an exemplary computing system comprised of a plurality of processing devices 20/68 linked via a network 12, such as a wide area network or the Internet, is illustrated. Processing devices 20, illustrated in the exemplary form of a device having conventional computer components, are provided with executable instructions to, for example, provide a means for a user to access a remote processing device, e.g., a server system 68, via the network 12 to, among other things, perform a search for products and/or services (individually and collectively referred to hereinafter as “products”), purchase products, provide ratings/comments with respect to a product generally and/or one or more characteristics of a product, and review such user provided ratings/comments. Generally, the computer executable instructions reside in program modules which may include routines, programs, objects, components, data structures, etc. that perform particular tasks or implement particular abstract data types. Accordingly, those skilled in the art will appreciate that a processing device 20 may be embodied in any device having the ability to execute instructions such as, by way of example, a personal computer, mainframe computer, personal-digital assistant (“PDA”), cellular or smart telephone, tablet computer, mobile computing device, or the like. Furthermore, while described and illustrated in the context of discrete processing devices 20, those skilled in the art will also appreciate that the various tasks described hereinafter may be practiced in a distributed or cloud-like environment having multiple processing devices linked via a local or wide-area network whereby the executable instructions, required data, etc. may be associated with and/or executed by one or more of multiple processing devices.

For performing the various tasks in accordance with the executable instructions, a processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional, external memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, camera, picture editor, etc.), other program modules 50, and/or program data 52. Still further, computer-executable instructions may be downloaded to one or more of the computing devices as needed, for example, via a network connection.

A user may interact with the various application programs, etc. of a processing device 20, e.g., to enter commands and information into the processing device 20, through input devices such as a touch screen or keyboard 54 and/or a pointing device 56. While not illustrated, other input devices may include a microphone, a joystick, a game pad, a scanner, a camera, a gesture recognizing device, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

A processing device 20 may also utilize logical connections to one or more remote processing devices, such as the server system 68 having one or more associated data repositories 68A in which is stored, for example, product information and customer information. In this regard, while the server system 68 has been illustrated in the exemplary form of a computer, it will be appreciated that the server system 68 may, like processing device 20, be any type of device having processing capabilities. Again, it will be appreciated that the server system 68 need not be implemented as a single device but may be implemented in a manner such that the tasks performed by the server system 68 and/or data needed for performance of such tasks are distributed to a plurality of processing devices linked through a communication network, e.g., implemented in the cloud. Additionally, the server system 68 may have logical connections to other third party server systems via the network 12 as needed and, via such connections, will be associated with data repositories that are associated with such other third party server systems.

For performing tasks, the server system 68 may include many or all of the elements described above relative to the processing device 20. By way of further example, the server system 68 includes executable instructions stored on a non-transient memory device for, among other things, handling search requests, providing search results, accepting user ratings/comments information, for displaying user ratings/comments information, etc. Communications between the processing device 20 and the server system 68 may be exchanged via a further processing device, such as a network router, that is responsible for network routing. Communications with the network router 72 may be performed via a network interface component 73. Thus, within such a networked environment, e.g., the Internet, World Wide Web, or other like type of wired or wireless network, it will be appreciated that program modules depicted relative to the processing device 20, or portions thereof, may be stored in the memory storage device(s) of the server system 68.

As noted above, the subject system and method functions to provide a user with access to user provided reviews and/or comments for a product. By way of example only, the following describes a method by which a user may access such user provided reviews and/or comments from a product detail web page, i.e., a web page that is presented to the user which provides detailed information about a single product. It is to be appreciated, however, that the method described hereinafter for providing access to such user provided reviews and/or comments can be equally applied to other common types of e-commerce web pages which other common types of e-commerce web pages can present to the user one or more products available for review and/or purchase, such as search result web pages, etc., and/or can be used in connection with product that is presented to the user in various different forms and/or manners, such as in association with product presented in a product recommendation section of a web page, product presented in an auto-complete suggestion box, text entry search field, etc. Thus, the illustrated and described embodiment is not intended to be limiting.

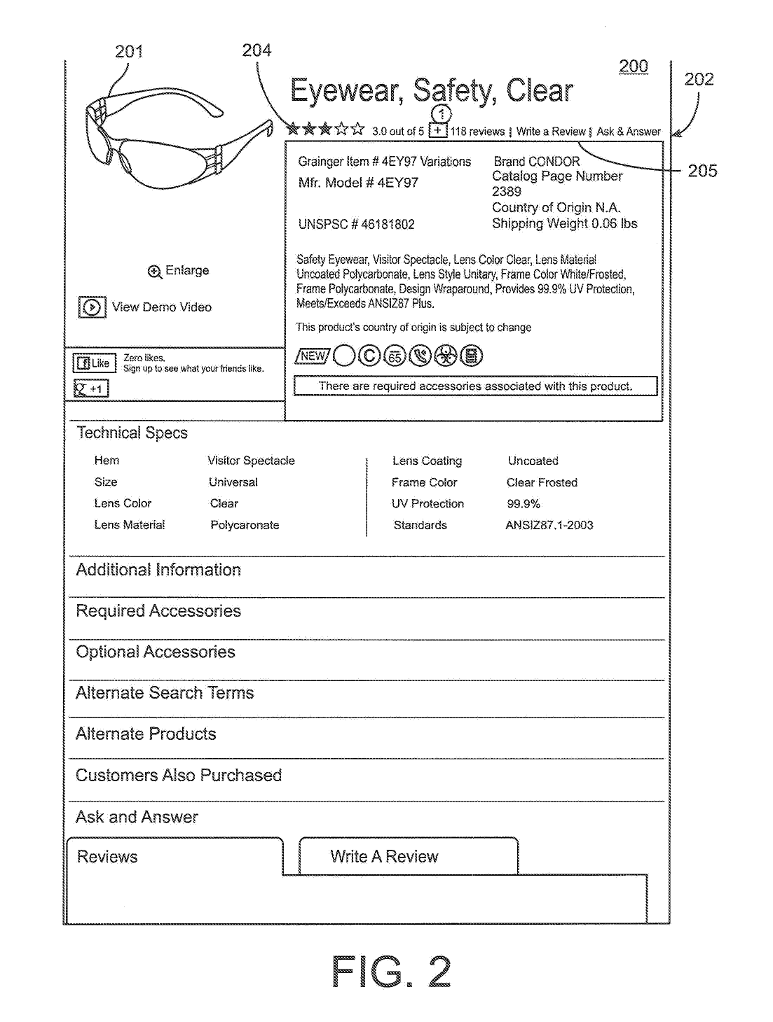

Considering now FIG. 2, an exemplary product detail web page 200 is illustrated. As will be understood by those of skill in the art, the product detail web page 200 may be accessed (i.e., caused to be displayed on processing device 20) as a result of a user interacting with server system 68, e.g., by performing a keyword search, a drill down search, clicking on (i.e., activating) a product link, and the like. In the illustrated, exemplary product detail web page 200 information about the product, e.g., product “4EY97,” and links to further information about the product, related products, recommended products, etc. and/or links to functionalities provided by the system server 68, such as a link to a demo video, a link to place the item in a shopping cart, etc., are provided. Additionally included in product detail web page 200 is an overall average rating 204 that has been provided for the product by users (e.g., the overall rating for product “4EY97” is three out of five). Preferably, the overall average rating 204 is presented in a dashboard 202 that is located at or near the top of the product detail web page 200 adjacent to an image 201 of the product. As will be appreciated, the use of dashboard 202 functions to provide a user with a quick visual summary of the overall average product rating 204 as well as, in this example, a visual indication of the number of reviews that have been submitted by users (e.g., 118 reviews) and one or more links for allowing a user to access functionality, such as a link 205 for accessing functionality for submitting an additional review for the product.

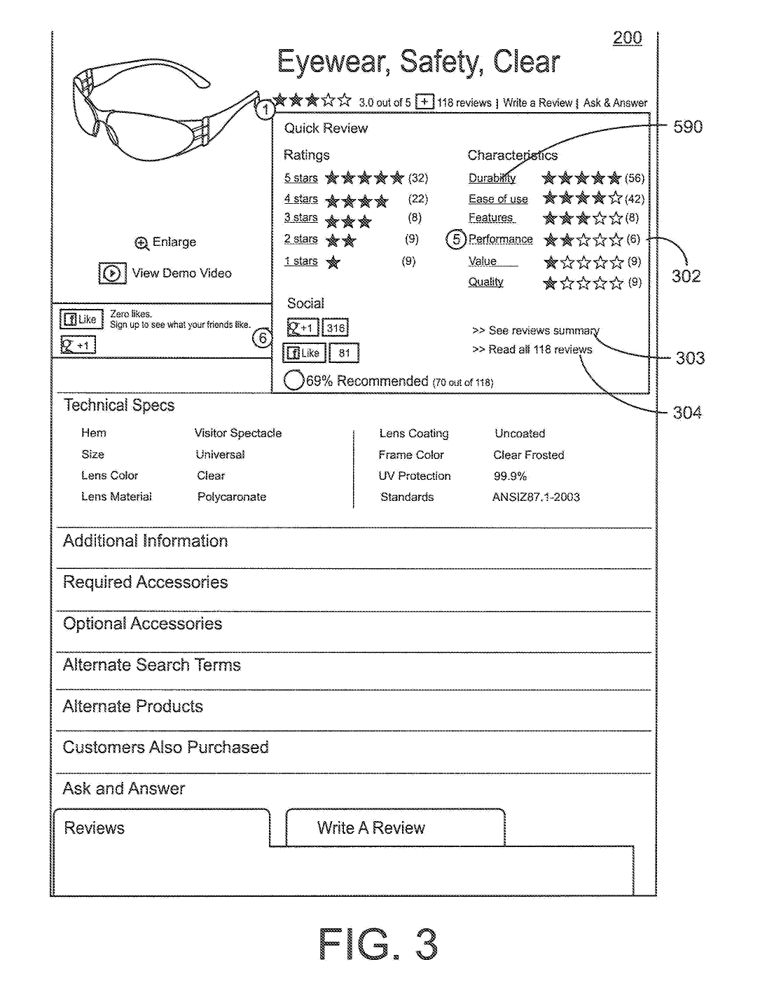

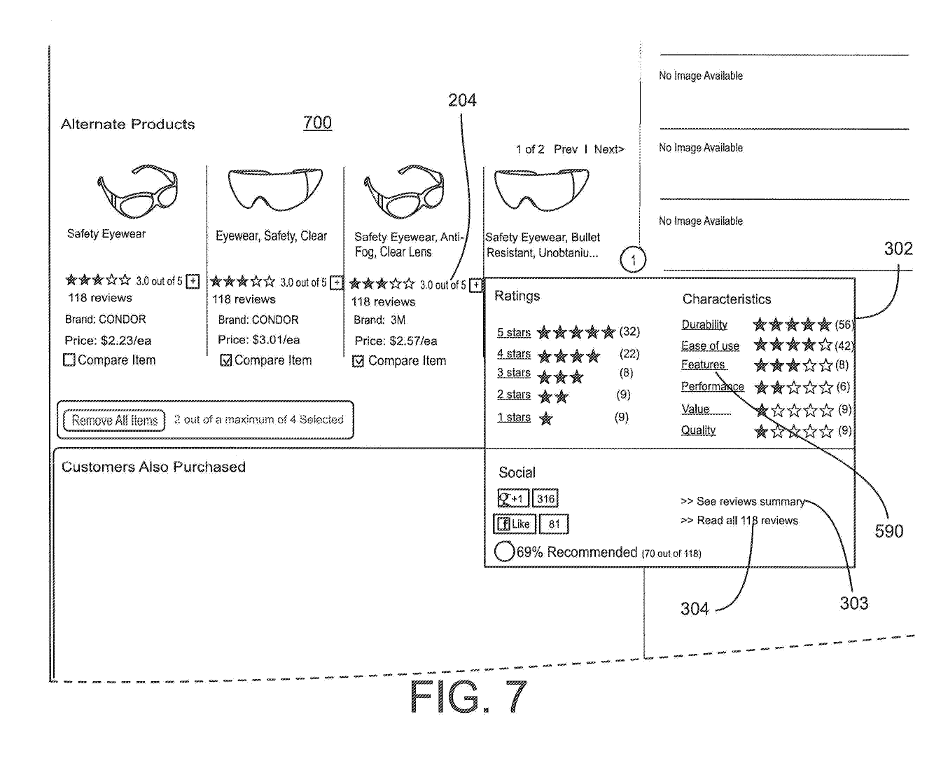

Turning now to FIGS. 3 and 7, in response to a sensed user interaction with the product detail web page 200, a product in a merchandizing area of a web page 700 (e.g., a product recommendation area, suggested or necessary accessories area, etc.), etc., for example, in response to a user mousing over (e.g., causing a cursor to move over) an icon or clicking on a link provided in the dashboard 202, the system server 68 further causes detailed product review information to be displayed to the user. In the example illustrated in FIGS. 3 and 7, the detailed product review information is caused to be displayed in a pop-up window 302. Alternatively, the detailed product review information can be displayed in another area of the product detail web page 200, in a further web page, or the like without limitation. As will be appreciated, when the detailed product review information is caused to be displayed in this manner, a user is provided with a quick and convenient visualization of the relevant product review data for the product including, but not limited to, a visualization of the number of users that have given the product a five star overall rating (e.g., 32), a visualization of the number of users that have given the product a four star overall rating (e.g., 22), a visualization of the number of user that have given the product a three star overall rating (e.g., 8), etc. as well as a visualization of the average overall rating users have given to features of, uses for, and/or characteristics of the product (individually and collectively referred to herein as “characteristics”) such as the overall average rating for the “durability” of the product (e.g., five star average from 56 users), the overall average rating for the “ease of use” of the product (e.g., four star average from 42 users), etc. Still further, the detailed product review information may include a visualization of the social history of the product such as, for example, the number of times a product has been shared, recommended, “liked,” posted, etc. via use of a social networking web site such as Facebook, Google+, Pinterest, etc.

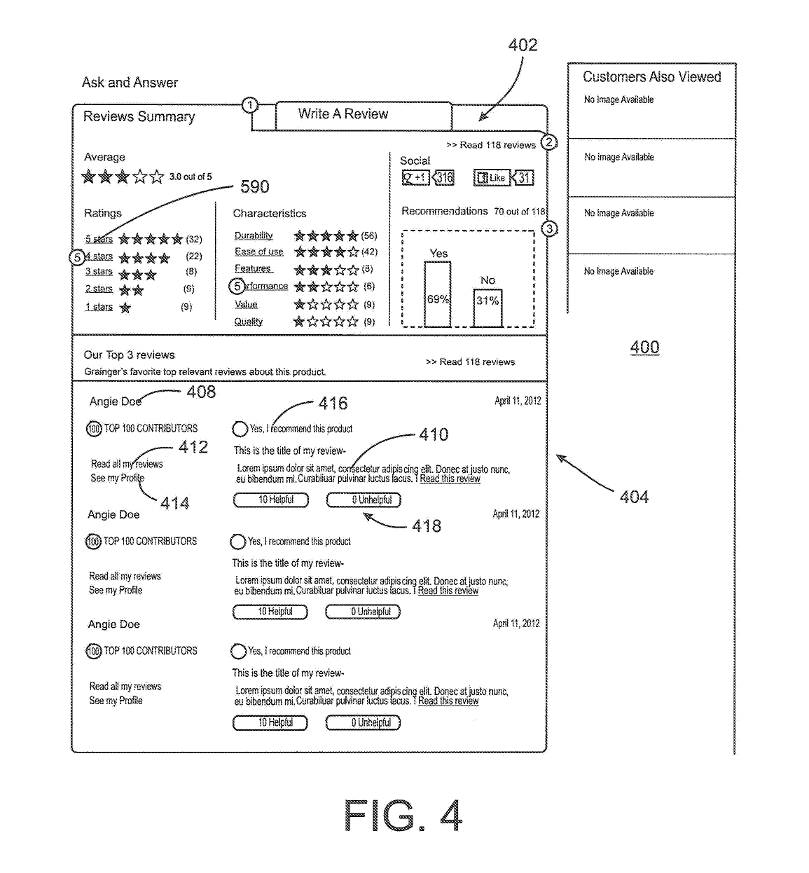

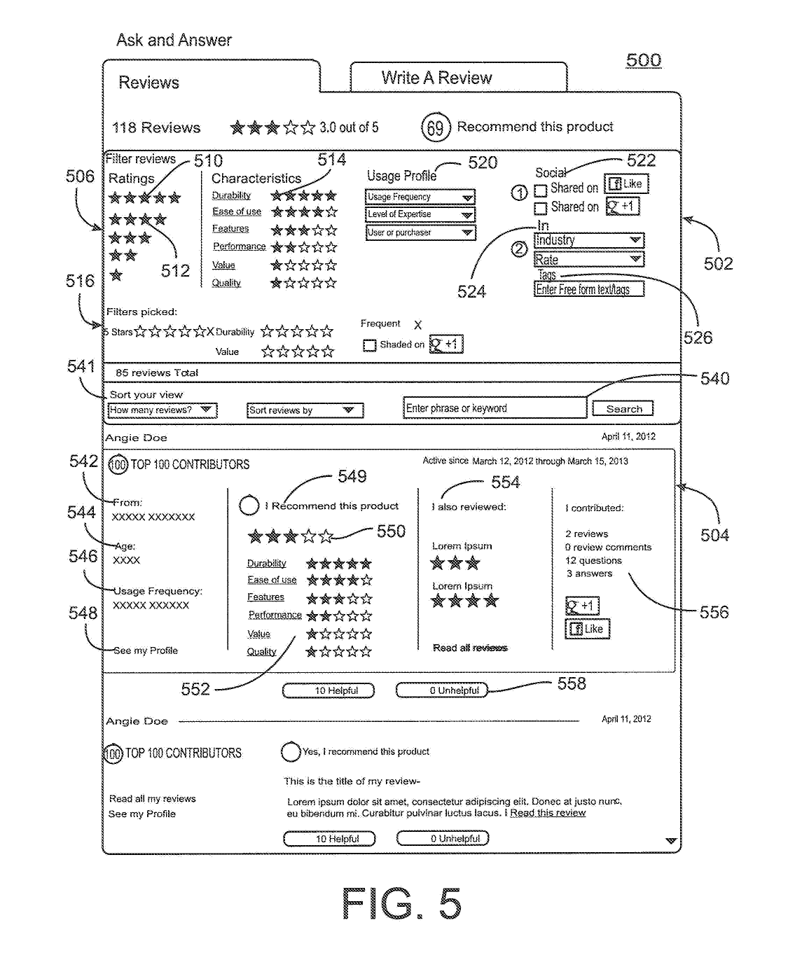

In addition to providing a visualization of the product information as above described, the detailed product review information may include a link 303 which, when activated by a user, will cause the system server 68 to display a reviews summary web page, pop-up, or otherwise cause a reviews summary web page area to be displayed (an example of which is illustrated in FIG. 4) and a link 304 which, when activated by a user, will cause the system server 68 to display an all reviews web page, pop-up, or otherwise cause an all reviews web page area to be displayed (an example of which is illustrated in FIG. 5). As will be understood, the reviews summary 400 is intended to visually present a limited amount of information to users that are undecided about a product and not yet committed to proactively filtering through a large amount of information as would be provided when the all reviews information is requested for display.

Turning to FIG. 4, an exemplary reviews summary 400 is illustrated. The reviews summary 400 is intended to provide a visual top line summary of product reviews along with a curated set of reviews, e.g., as moderated by the Web site host—typically a vendor of product. Preferably the reviews summary 400 is divided into two sections. As with the product reviews detailed information pop-up 302, a top section 402 of the reviews summary 400 may again present a visualization of the relevant product review data for the product including, but not limited to, a visualization of the overall average rating provided to the product (e.g., 3 stars out of 5 stars), a visualization of the number of users that have given the product a five star overall rating (e.g., 32), a visualization of the number of users that have given the product a four star overall rating (e.g., 22), a visualization of the number of user that have given the product a three star overall rating (e.g., 8), a visualization of the number of user that have given the product a two star overall rating (e.g., 9), a visualization of the number of user that have given the product a one star overall rating (e.g., 9), a visualization of the average overall rating users have given to characteristics of the product such as the overall average rating for the “durability” of the product (e.g., five star average from 56 users), the overall average rating for the “ease of use” of the product (e.g., four star average from 42 users), etc., a visualization of the social history associated with the product, and a visualization of the recommendations history for the product. In addition, the top section 402 of the reviews summary 400 may include a link by which a user can request that the system server 68 present the all reviews information discussed above. Meanwhile, the bottom section 404 of the reviews summary 400 includes the curated reviews, e.g., the “top reviews” as selected by the web site operator and/or as selected by other users. Information presented with the curated reviews can include, in addition to review 410 (which may be presented in its entirety or partially with a link to the entirety of the review), a reviewer identifier 408, such as an author name or the like, date of the review, a link 412 to other reviews by that reviewer, a link 414 to a profile of that reviewer, a visual indication 416 that the reviewer “recommends” the product, visual indications 418 as to how helpful or unhelpful the review was to users, etc. The visual indicators 418 can be interactive as desired, e.g., a user can click of the visual indicators to advance the tally that is displayed. As shown in FIG. 4, the reviews summary 400 can be presented using a tabbed page metaphor or the like to thereby allow a user to quickly access one or more informational and/or interactive displays associated with the review functionality described herein.

Turning to FIG. 5, an exemplary all reviews informational area 500 is illustrated. The all reviews informational area 500 is intended to provide information that can be actively interacted with by a user, e.g., filtered, sorted, etc. Preferably the all reviews informational area 500 is divided into two sections. A top section 502 may again present a visualization of the overall average rating provided to the product (e.g., 3 stars out of 5 stars), a visualization of the number of users that have given reviews, a visualization of the number of users that have recommended the product, etc. In addition, the top section 502 provides a user with tools 506 used to actively interact with the informational content. By way of non-limiting example, the tools 506 can be user selectable filters that allow the user to limit the types of reviews that will be presented in the bottom section 504, e.g., to indicate 510 that only 5 star reviews are to be displayed in bottom section 504 (or to bias such reviews to the top of the displayed information), to indicate 512 that only 4 star reviews are to be displayed in bottom section 504 (or to bias such reviews to the top of the displayed information), to indicate 514 that only a given number of star reviews (such as 3 stars, 4 stars, or 5 stars depending on the star or stars interacted with) in a given product characteristic (such as durability or ease of use) are to be displayed in bottom section 504 (or to bias such reviews to the top of the displayed information), etc. Additional tools 506 may be provided to allow a user to select filtering based upon usage profiles 520, social network 522 in which the product is shared, industry or role 524 of the sharer or network in which the information is shared (so users can review products that are being shared and reviewed by people in similar roles and in similar industries) and/or tags 526 provided to the product and/or reviews. As further illustrated, the filters can be predetermined and presented in/accessed by use of drop down menus and/or can be free-form, e.g., entered into free form text entry fields. A filter selected informational area 516 is also provided to allow a user to quickly visualize the filters that are currently being applied by the system server 68 when causing the information to be displayed. A total number of reviews meeting the currently established filter criteria can also be displayed to the user.

By way of non-limiting example, filtering options based upon usage profiles 520 may be used to allow for filtering based upon reviewer indicated usage frequency of a product, e.g., daily, weekly, after first deep freeze, when building is unoccupied, for the first week after . . . , etc., reviewer indicated level of expertise within an industry and/or with the product, e.g., none, professional, trained and certified, tradesman, X years of use, etc., reviewer indicated role in an organization, e.g., senior buyer, company owner, end user, stock room operator, etc., and the like. Additionally, the filtered reviews that are presented in the bottom section 504 can be searched, for example, by using one or more keywords provided in free-form text entry field 540 and/or sorted 541 based upon the number of reviews provided by a reviewer, e.g., 1 to 10, 11-50, more than 50, top 100 contributor, etc., and/or based upon other metrics such as, best rating to lowest rating, lowest rating to best rating, best level of reviewer expertise to lowest level of reviewer expertise, highest number of reviews provided to lowest number of reviews provided, industry role (alphabetical), etc. As will be understood, such filter options can be selected as needed for any particular purpose and the examples set forth above are not intended to be limiting. Furthermore, as a user selects one or more filters for application to the reviews, other selectable filtering options can be removed, greyed-out, or the like, to indicate that such filtering options would no longer be applicable given the filtering options that have been so selected by the user, e.g., in the case where no “professional” reviewers have indicated “daily frequency of use,” when either of these filter options are selected, the other of these filtering options can be removed as not being meaningful to further refine the results presented.

The reviews provided in the bottom section 504 may again include information about the reviewer, such as their user name 542, age 544, usage frequency 546, a link 548 to their profile, a visual indication 549 that the reviewer “recommends” the product, a visual indication of the overall product rating 550 provided by the user, visual indications of the product characteristic ratings 552 provided by the user, a listing of and/or links to other reviews provided by that user 554, a listing of and/or links to other contributions made by that user 556, visual indications 558 as to how helpful or unhelpful the review was to users, etc.

In the event that user interacts with, e.g., clicks on, a rating, e.g., an overall rating or a characteristic rating, the system server 68 may respond by directing the user to the all reviews area 500 with the interacted with rating being automatically used as a filter option when presenting the reviews to the user in the bottom section 504.

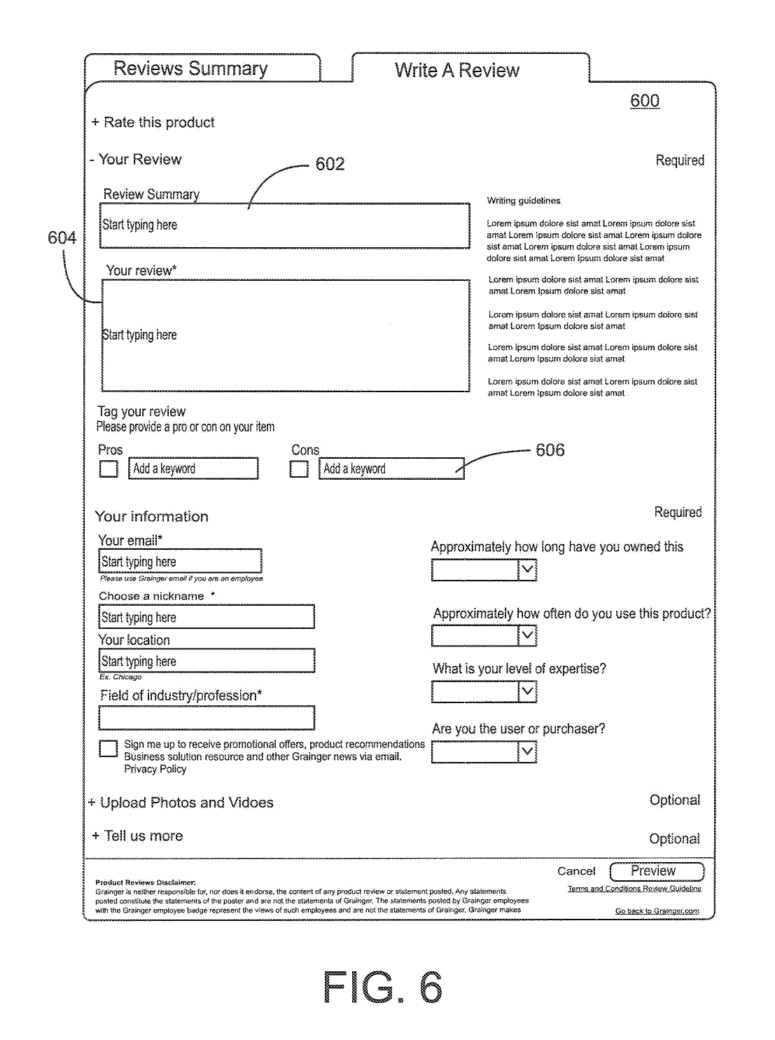

For gathering the review-related information from users, which review-related information is preferably stored in data repository 68A associated with system server 68, an interactive write a review area/web page 600 is provided, an example of which is illustrated in FIG. 6. Using the tools provided in the write a review area 600 a user can select a star rating to provide to a product generally and/or characteristics of a product, can provide a free-form summary of their review in a text entry field 602, can provide a detailed review in text entry field 604, can enter one or more tags, e.g., positive and/or negative comments, to be associated with a product in text entry fields 606 (which tags can be rendered searchable for assisting others in finding product of interest), etc. In addition, the form provided on page 600 can be used to capture reviewer profile information, e.g., email address, name, location, as well as the information usable to provide sorting and filtering as described above, e.g., frequency of product usage, level of expertise, role with product, etc. In this regard, the information to be obtained from the reviewer for the purpose of facilitating sorting and/or filtering should be made selectable via use of drop-down menus or the like and the selectable options should be the same as the selectable options that are made available to a user for performing sorting and/or filtering of review results. Information that is required from a user should be opened by default when the review area 600 is presented. Areas for receiving optional information from a reviewer, such as uploaded photos or video, can be made collapsible where the user can open/collapse these areas via use of +/−controls, respectively. The location field can be pre-populated with information considering, for example, an IP address or geo-location information of a user.

As noted above, the system may include functionality whereby a user can provide tags 606 for the product and/or reviews. In certain circumstances such tags can be used to generate ratable, user-defined characteristics of a product. For example, a user may tag that product “4EY97” is “good for use in paintball.” If a predetermined number of additional reviewers provide tags which use the same or similar keyword (with similar keywords being established within a created thesaurus), the system may automatically generate a ratable characteristic using that keyword, e.g., a “good for paintball” ratable characteristic. Such user-defined, ratable characteristics of a product can be presented with the pre-defined ratable characteristics of a product in top section 502, in another, separate section dedicated to user-defined, ratable characteristics, or the like without limitation. In addition, a system curator, other users, or the like can cause any such user-defined, ratable characteristic to be presented in lieu of, more prominently than, etc. a pre-defined ratable characteristic as appropriate. Still further, it will be appreciated that other user provided content, for example, information provided by a user in the review section 604 or review summary section 602, can also be examined to discern if there is a recurring use of keywords or themes that would indicate that such keywords or themes would be appropriate for use in auto-generating ratable characteristics (or manually by a curator) in the manner discussed above.

While various concepts have been described in detail, it will be appreciated by those skilled in the art that various modifications and alternatives to those concepts could be developed in light of the overall teachings of the disclosure. For example, while various aspects of this invention have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

What is claimed is:

1. A computer-readable media embodied in a non-transient, physical memory device having stored thereon computer executable instructions for presenting product review information to a user, the instructions performing steps, comprising:
presenting on a plurality of client computing device user interface elements for receiving review information from a plurality of product reviewers for a product wherein the user interface elements comprise at least one text entry field for receiving from each of the product reviewers product reviewer generated content;
automatically transforming the product reviewer generated content into a ratable characteristic of the product in response to a same or equivalent keyword being used a predetermined number of times in product reviewer generated content received from the plurality of product reviewers via the at least one text entry field;
causing an image of a product and a ratings dashboard to be presented on a further client computing device wherein the ratings dashboard is associated with the image of the product and wherein the ratings dashboard provides a quick visual summary of review information provided by product reviewers which information includes at least a visualization of an average overall product reviewer rating for the product;
in response to a sensed user interaction with the ratings dashboard retrieving from a database review information provided by product reviewers, using the retrieved information provided by product reviewers to determine at least a number of product reviewers that have given the product each of a plurality of overall product reviewer ratings and an average overall product reviewer rating of at least the ratable characteristic of the product, and causing a quick review summary for the product to be presented on the further client computing device wherein the quick review summary for the product provides a top line visual summary of at least the number of product reviewers that have given the product each of a plurality of overall product reviewer ratings and the average overall product reviewer rating of at least the ratable characteristic of the product; and
in response to a first sensed user interaction with the quick review summary for the product causing information related to all product reviewer reviews for the product to be presented on the further client computing device wherein the presented information related to all product reviewer reviews for the product is capable of being at least one of sorted and filtered.

2. The computer-readable media as recited in claim 1, wherein the image of the product and the ratings dashboard are presented in a product detail page.

3. The computer-readable media as recited in claim 1, wherein the image of the product and the ratings dashboard are presented in a merchandizing area of a product detail page.

4. The computer-readable media as recited in claim 1, wherein the image of the product and the ratings dashboard are presented in a web page and wherein the quick reviews summary is presented in a pop-up of the web page.

5. The computer-readable media as recited in claim 4, wherein the presented information related to all product reviewer reviews for the product is presented in a further web page.

6. The computer-readable media as recited in claim 1, wherein the information of the review summary for the product includes a visualization of a number of product reviewers that have recommended the product.

7. The computer-readable media as recited in claim 1, wherein in response to a second sensed user interaction with the quick review summary for the product causing a reviews summary to be presented on the further client computing device wherein the reviews summary includes information related to product reviewer reviews for the product as provided by less than all of the product reviewers as well as the visualization of at least a number of product reviewers that have given the product each of a plurality of overall product reviewer ratings.

8. The computer-readable media as recited in claim 7, wherein in response to a third sensed user interaction with the quick review summary for the product causing information related to all product reviewer reviews for the product to be presented on the further client computing device wherein the presented information related to all product reviewer reviews for the product is capable of being at least one of sorted and filtered.

9. The computer-readable media as recited in claim 8, wherein in response to a sensed user interaction with the visualization of the number of product reviewers that have given the product a one of the plurality of overall product reviewer ratings causing the information related to all product reviewer reviews for the product as presented on the further client computing device to be at least one of sorted and filtered considering the interacted with visualization of the number of product reviewers that have given the product a one of the plurality of overall product reviewer ratings.

10. The computer-readable media as recited in claim 8, wherein in response to a sensed user interaction with the a visualization of an average overall product reviewer rating of at least one characteristic of the product causing the information related to all product reviewer reviews for the product as presented on the further client computing device to be at least one of sorted and filtered considering the interacted with visualization of an average overall product reviewer rating of at least one characteristic of the product.
